(19) United States
(12) Patent Application Publication
(10) Pub. No.: US 2006/0118589 A1
(43) Pub. Date: Jun. 8, 2006

(54) Smokeless tobacco product user package

(76) Inventors: Jan Arnarp, (US); Fredrik Hodin, (US); Jorgen Lundin, (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/426,017

(22) Filed: Apr. 29, 2003

(51) Int. Cl. B26F 3/02

(52) U.S. Cl. 225/43; 225/66; 225/80

(57) ABSTRACT

A smokeless tobacco product user package (10). The package comprises a closed housing (12) containing a continuous band comprising the smokeless tobacco product (42). An opening (20) in the housing (12) exposes an outer end (46) of the continuous band outside the housing (12), and allows outfeed of the continuous band from the housing (12) and separation of a desired length of the outer end (46) by the user. A reclosable closure means (26) is provided for alternatively covering and exposing the outer end (46) of the continuous band outside the housing (12).

### FIELD OF THE INVENTION

The present invention relates to smokeless tobacco product user packages.

### DESCRIPTION OF RELATED ART

Today, tobacco products, particularly in the form of oral snuff, are commonly available in powder form, where the user picks a snuff dose by his/her fingers from an open package. In order to provide oral snuff in a more hygienic and clean manner, it is also known to package oral snuff in separate small bags, each having a predetermined amount of snuff stored therein.

### SUMMARY OF THE INVENTION

An object with the present invention is to further improve the packaging of smokeless tobacco doses so that the tobacco product at each single instance is more easily accessible to the user in a wider range of desired amounts.

According to one aspect the invention provides a smokeless tobacco product user package, comprising a closed housing for containing a continuous band comprising said smokeless tobacco product, an opening in said housing for exposing an outer end of said continuous band outside said housing and allowing outfeed of said continuous band from said housing and separation of a desired length of said outer end by the user, and a reclosable closure means for alternatively covering and exposing said outer end of said continuous band outside said housing.

The package preferably also has a cutting means outside said housing for said separation of the desired length of said outer end outside the housing. In a preferred embodiment the cutting means is connected to the housing or the closure to thereby effect said cutting when said closure is manually closed by the user.

The smokeless tobacco product is suitably an oral snuff product.

Other objects and advantages of the invention are apparent from the following detailed description and the claims.

### BRIEF DESCRIPTION OF THE DRAWING

FIG. 1 is perspective view of a first embodiment of a smokeless tobacco product user package according to the invention;

FIG. 2 is an exploded view of a package shown in FIG. 1;

FIG. 3 is an exploded perspective view of a second embodiment of a smokeless tobacco product user package according to the invention;

FIG. 4 is a perspective view of a continuous band of a smokeless tobacco product for a package according to the invention;

FIG. 5 is an exploded perspective view with parts broken away showing a continuous band of a smokeless tobacco product arranged for outfeed from a package by rotation of a part of the package;

FIG. 6 is a fragmentary view, partially in section, showing an alternatively manner of storing a smokeless tobacco product in a package according to the invention;

FIG. 7 is a perspective view of another embodiment of another smokeless tobacco product user package container according to the invention;

FIG. 8 is a perspective view of a bottom housing half of the container according to FIG. 7; and

FIG. 9 is a perspective view of a spool for a continuous band of a smokeless tobacco product to be used in a package according to the invention.

### DETAILED DESCRIPTION OF PREFERRED EMBODIMENTS

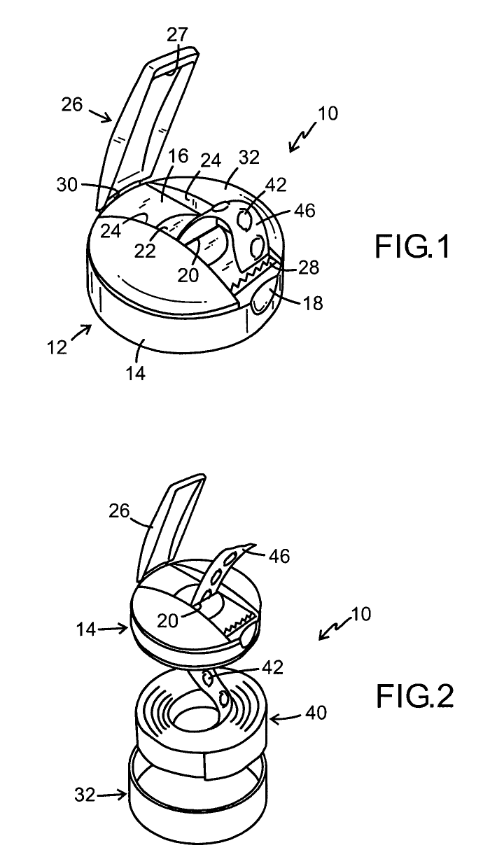

The smokeless tobacco product according to the invention, in one embodiment comprises a so called oral snuff product comprising a particulate or powdery tobacco product that is provided in portions 42 (FIG. 1-3 and 6) either in a powder state (not shown) or a pellet shape having a tobacco dough consistency, where in the latter case a thickening agent could be added to the tobacco product powder.

The portions 42 are packaged in pockets one after another in a spaced relation between layers of flexible sheet bonded together face to face and forming a band or ribbon 40. The flexible sheet is preferably a paper, for example a non-woven paper, permeable to tobacco ingredients and well-known in the art for oral snuff portion bags. The layers of flexible sheet may be composed optionally of two separate sheets or a single sheet that is folded once over itself (not shown).

In another embodiment shown in FIG. 4 the smokeless tobacco product 42 itself forms the continuous band 40. In this embodiment, a thickening agent is also added to the wet tobacco product to change the consistency making the flexible band shape possible.

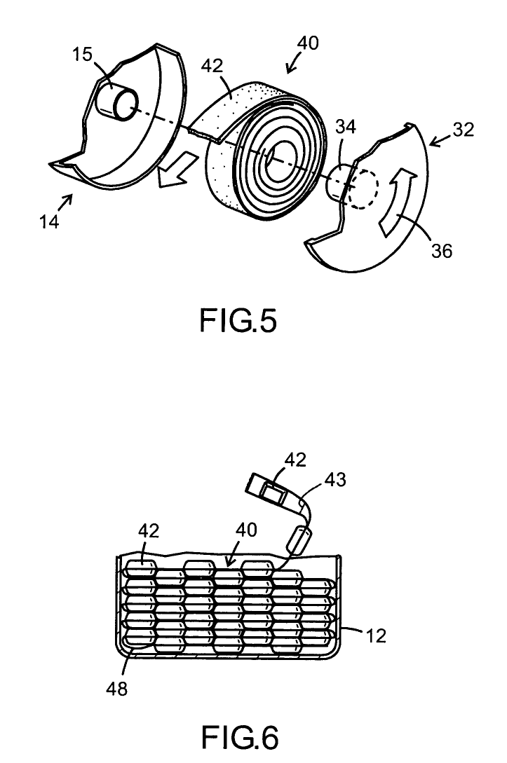

According to the invention, the band is contained in a package 10 comprised of a small snuff box, container or housing 12, where the band 40 is compacted into a wound roll shape or a compressed meander or zigzag shape (FIG. 6). Preferably, a free end 46 of the band 40 is exposed from an opening 20 in the housing 12 so that the user can pull a desired length of smokeless tobacco product 18 from the housing 12 and tear off the desired length of band 40.

In the preferred embodiment, the opening is a slit 20 defined by a pliable or yielding piece 22 of material that allows pulling the band 40 forward but prevents the free end 46 of the band 40 from unintentionally slipping back into the container 12. The material is preferably a flexible plastic film 22 that flexes outwards on pulling the free end 46 but may also be other pliable materials such as an expanded pliable plastics material (not shown).

A reclosable lid or closure means 26 is connected by an integral hinge 30 to one 14 of two halves 14, 32 defining the housing 12. In its closed position (not shown) the lid covers the free end 46 of the band 40 in a closed space defined by a recessed wall 16 of the housing half 14, housing side wall portions 24, 24 and the lid 26. Snap lock means (not shown) on the side wall portions 24 and/or the lid 26 will lock the lid 26 in its closed position until its opened by the user putting his/finger into a recess 18 under a protruding free end of the lid and forcing it upwards.

To facilitate the separation of the band 40, band 40 can be provided with weakened lines such as perforations 43 (FIG. 6) between each pair of portions 20 in the case of pocketed portions. In the case of continuous tobacco product according to FIG. 4, the smokeless tobacco dough is easily tearable in itself but may if needed also be provided with weakening lines such as traversing depressions (not shown) defining the product portions therebetween.

In the shown embodiments the box 12 is, however, provided with a cutting means in the shape of a knife 28 or the like for cutting the band apart at a distance from the opening 20 exposing the free end 46 of the band 40. More precisely, the user pulls the free end 46 of the band 40 a desired length past the range of the lid 26 and then manually closes the lid, whereby the knife 28 becomes effective to cut the desired length off outside the closed lid 26.

In the embodiment shown in FIGS. 1 and 2, the knife 30 is mounted on the recessed wall 16. The knife is cooperating with a counter edge 27 on the lid 28 to facilitate the cutting action.

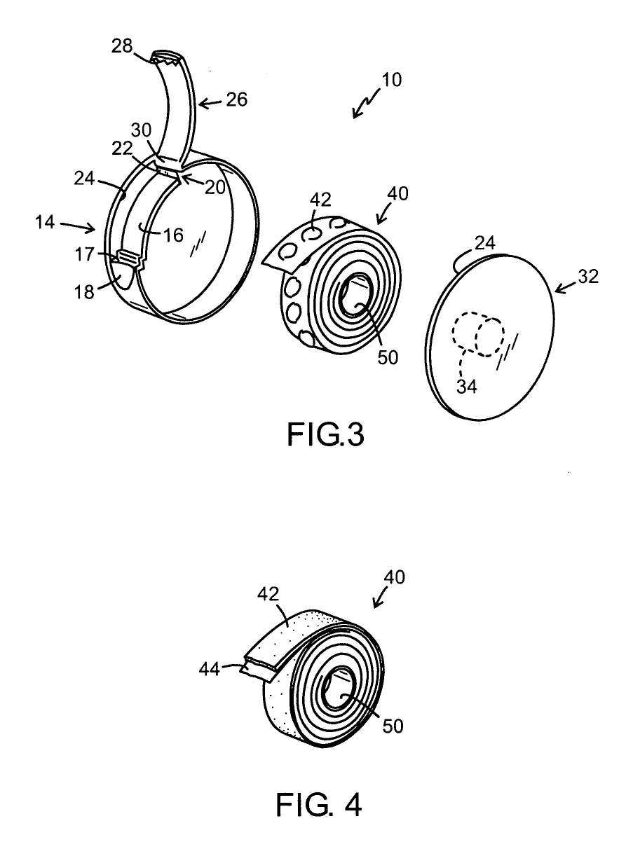

In the embodiment shown in FIG. 3 the knife 28 is mounted on the lid 26. In this case, the knife 28 is cooperating with a counter edge 17 on the housing 12. To have a still cleaner cut, the knife 28 may be received in a narrow slit in the respective counter part when the lid 26 is closed (not shown).

In the embodiments of FIGS. 1-4 the band 40 is stored in the shape of a wound roll in the housing 12.

In the embodiment of FIGS. 1 and 2, the free end 46 of band 40 is taken from the inside of a stationary wound roll. In this arrangement the band 40 inevitably becomes twisted when pulled straight out from the housing 12. To overcome this problem, the compliant slit 20 can suitably be slightly over dimensioned for allowing folds resulting from this twisting of the band 40 to pass through the slit 20 (not shown).

In the embodiments of FIGS. 3 and 4, the band 40 is wound onto a bearing sleeve 50 which is journalled on a shaft 34 protruding from the inside of the housing half 32.

As mentioned in the foregoing, the continuous smokeless tobacco band 40 of FIG. 4 has a dough consistency. This may cause the individual turns of the roll to stick to each other. Therefore, the turns are preferably separated by a ribbon 44 of a non-adhesive material such as a release paper well known in the art.

The continuous smokeless tobacco band 40 may also be relatively stiff compared to the highly flexible non-woven paper material supporting the product portions 42 in the embodiment of FIG. 3. Instead of pulling the band 40 out of the housing it is therefore in this case also possible to push it out from the inside. To this end, as is indicated in FIG.6, the band 40 may be directly wound stuck onto the hollow shaft 34 which in turn is journalled as a sleeve on a counter shaft 15 protruding form the other housing half 14. Accordingly, when the user rotates housing half 32 in the direction of arrow 36 relative to housing half 14, the free end of band 40 will be pushed out of the package.

In the embodiment shown in FIG. 6 the band 40 of smokeless tobacco portions 42 is packed in a dense meandering manner in a parallelepipedic housing 12. In order that the portions will effectively fill out the interior of the housing 12, the band 40 and portions 42 are spaced and shaped in a complementary manner so that when the band is folded back over itself, elevated portions 42 of one side of one part of the band 40 will fit into the voids of an opposing side of an adjacent part of the band 40.

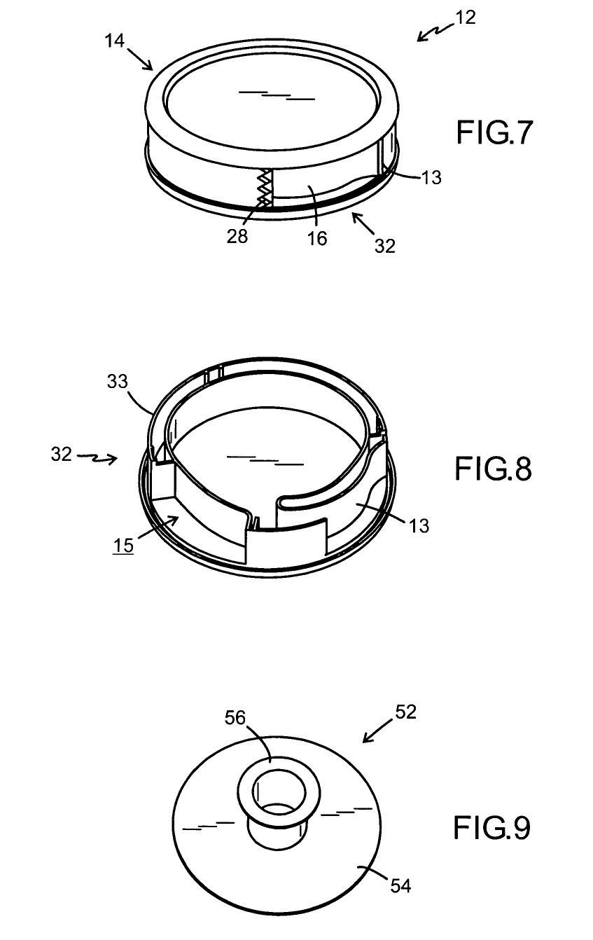

An alternative embodiment of a container or housing 12 according to the invention is shown in FIG. 7. In this case the upper half 14 of housing 12 is formed as a cover that is rotatably supported on a peripheral rim 33 (FIG. 8) on the bottom half 32 of the housing. The upper half 14 has a peripheral opening 13 in its peripheral wall, serving as a closure means 26, for exposing the above mentioned closed space outside the recessed wall 16 in the rotational position shown in FIG. 7 of the upper half 14. The bottom half 32 of the housing has further an additional space 15 for storing used product portions. The additional space is fully exposed by rotating the upper half 14 relative to the bottom half 32 approximately 90 degrees clockwise from the position shown in FIG. 7.

Further, in this alternative embodiment the cutting means 28 is formed at one of the lateral edges of the peripheral opening 13. In this case, the free end of the band (not shown) is separated by the cutting means, for example by rotating the upper half 14 counter-clockwise in FIG. 7 until the free end of the band is trapped between the cutting means 28 and the opposite end of the closed space outside the recessed wall 16. Thereafter the user can tear the free end apart from the band.

FIG. 9 finally shows a spool 52 as an alternative for the bearing sleeve 50 (FIG. 3, 4) and having a pair of opposite radial retaining flanges 54, 56.

1. A smokeless tobacco product user package (10), comprising:
a closed housing (12) for containing a continuous band (40) comprising said smokeless tobacco product (42);
an opening (20) in said housing (12) for exposing an outer end (46) of said continuous band (40) outside said housing (12), and for allowing outfeed of said continuous band (40) from said housing (12) and separation of a desired length of said outer end by the user; and
a reclosable closure means (26) for alternatively covering and exposing said outer end (46) of said continuous band (40) outside said housing (12).

2. The package according to claim 1, comprising a cutting means (28) outside said housing (12) for said separation of the desired length of said outer end (46) outside the housing (12).

3. The package according to claim 2, wherein said cutting means (28) is connected to the housing (12) or the closure means (26) to thereby assist in effect said cutting when said closure (26) is manually closed by the user.

4. The package according to claim 1, wherein said opening (20) comprises a narrow slit (20) defined by a compliant material (22) to prevent unintentional backward movement of said outer end (46) of the continuous band (40).

5. The package according to claim 1, wherein said continuous band (40) comprises a plurality of smokeless tobacco product portions (42) arranged in a spaced relation one after another.

6. The package according to claim 1, wherein said continuous band (40) comprises a continuous smokeless tobacco product (42).

7. The package according to claim 1, wherein said continuous band (40) is wound to a roll in said closed housing (12).

8. The package according to claim 7, wherein said roll is supported on a shaft (34) in said closed housing (12).

9. The package according to claim 1, wherein said continuous band (40) is stored in a compressed meandering fashion in said closed housing (12).

10. The package according to claim 1, wherein said smokeless tobacco product is an oral snuff.
